(19) United States
(12) Patent Application Publication
(10) Pub. No.: US 2022/0075863 A1
(43) Pub. Date: Mar. 10, 2022

(54) Trusted Key Provisioning Based on Device Specific Secrets

(71) Applicant: NUVIA, INC., San Diego, CA (US)

(72) Inventor: Osman Koyuncu, San Diego, CA (US)

(21) Appl. No.: 17/394,236

(22) Filed: Aug. 4, 2021

Related U.S. Application Data
(60) Provisional application No. 63/076,874, filed on Sep. 10, 2020.

(51) Int. Cl. G06F 21/44; H04L 9/32; H04L 9/08; H04L 9/14; H04L 9/30

(52) U.S. Cl. CPC G06F 21/44; H04L 9/3271; H04L 9/0861; G06F 2221/2103; H04L 9/14; H04L 9/30; H04L 9/0894

(57) ABSTRACT

A system on chip (SoC) includes one or more SoC dies each having a die identification and a die specific secret. A computer obtains the device identification of each chip and extracts from memory the device specific secret of each chip based on the device identification. A challenge is generated based on a random number and encrypted using a first key that is generated based on the die specific secret stored locally in association with each SoC die. After sending the challenge to the SoC, the computer receives a response. The response is generated based on the random number and encrypted using a second key that is generated by the SoC based on the device specific secret of each SoC die stored on the SoC. In accordance with a determination that the response matches the challenge, the computer authenticates the SoC for subsequent trusted operations.

### RELATED APPLICATION

This application claims priority to and the benefit of U.S. Provisional Application No. 63/076,874, filed on Sep. 10, 2020, titled “Trusted Key Provisioning Based on Device Specific Secrets,” which is herein incorporated by reference in its entirety.

### BACKGROUND

Sensitive data are normally communicated among electronic devices and across communication networks in an encrypted format, and users have to be authenticated before the sensitive data are communicated. Sophisticated authentication and encryption algorithms have been developed to enhance a security level of sensitive data, and keys are applied in many of these sophisticated authentication encryption algorithms. Keys are generated by software programs with or without seeds, and users have to keep the seeds and/or keys strictly confidential. It would be beneficial to have a more efficient authentication or encryption mechanism than the current practice.

### SUMMARY

Various implementations of systems, methods and devices within the scope of the appended claims each have several aspects, no single one of which is solely responsible for the attributes described herein. Without limiting the scope of the appended claims, after considering this disclosure, and particularly after considering the section entitled “Detailed Description” one will understand how the aspects of various implementations are used to provision a system on chip (SoC) with keys that are generated based on device specific secrets. This invention relies on multiple device specific secrets that are injected at different manufacturing phases of SoC dies (e.g., a main SoC die and a companion SoC die of the SoC) in a semiconductor foundry flow. In some implementations, if and only if the SoCs are activated to a secure and locked state, the device specific secrets are cryptographically combined and used by a hardware key generation block in the SoC. The hardware key generation block derives a set of device-unique symmetric keys and asymmetric key pairs. These keys or key pairs can be used according to data encryption and authentication protocols to interact with a computer, e.g., a hardware security module (HSM) computer applied in an assembly and test facility.

In some implementations, an SoC includes a plurality of SoC dies, and each SoC die stores a device specific secret in a secure memory of the respective SoC die. An example of the secure memory is one time programmable (OTP) memory, which is a multibit (e.g., 128-bit, 256-bit) non-volatile memory that includes electrical fuse and antifuse. A computer communicates with the SoC with a challenge response protocol to provision the SoC with keys and/or key pairs based on device-specific secrets of the SoC dies. Under some circumstances, the device specific secrets are destroyed, e.g., by overwriting each bit of the device specific secrets with is in the OTP memory or making a netlist associated with the device specific secrets inaccessible. In accordance with the challenge response protocol, the SoC is provisioned with a device-unique root secret and a set of cryptographic artifacts, including symmetric or asymmetric keys, which can be endorsed/certified by a supplier of the SoC. The device-unique root secret and cryptographic artifacts are not directly accessible to any software, after a corresponding provisioning process is completed based on the challenge response protocol.

In one aspect, a method for provisioning the SoC is implemented at a computer (e.g., the HSM) having one or more processors and memory for storing instructions. The computer is coupled to the SoC, and the SoC includes one or more SoC dies each of which has a die identification and a die specific secret. The computer generates a challenge based on a random number, including encrypting the challenge using a first key generated based on at least the die specific secret stored locally on the computer in association with each SoC die. For example, the first key is based on a combination of the device specific secrets of the one or more SoC dies. The challenge is sent by the computer to the SoC. The computer receives a response to the challenge from the SoC, and the response is based on the random number and is encrypted using a second key that is generated by the SoC based on at least the device specific secret stored on the SoC. The computer determines whether the response matches the challenge, and in accordance with a determination that the response matches the challenge, authenticates the SoC for subsequent trusted operations. Specifically, in some implementations, in accordance with authentication of the SoC, the computer generates a root secret, generates a plurality of keys based on the root secret, and stores the root secret and the plurality of keys permanently in a secure memory of the SoC.

From a broader perspective, in another aspect, a method for provisioning hardware is implemented at a computer having one or more processors and memory for storing instructions. The computer is coupled to a semiconductor system including one or more semiconductor chips. Each chip has a device identification and a device specific secret. The method includes obtaining the device identification of each chip and extracting from the memory the device specific secret of each chip based on the device identification. The method further includes generating a challenge based on a random number, including encrypting the challenge using a first key generated based on at least the device specific secret stored locally in the memory for each chip. The method further includes sending the challenge to the semiconductor system and receiving a response to the challenge from the semiconductor system. The response is generated based on the random number and is encrypted using a second key that is generated by the semiconductor system based on at least the device specific secret stored on the semiconductor system for each chip. The method further includes determining whether the response matches the challenge and in accordance with a determination that the response matches the challenge, authenticating the semiconductor system for subsequent trusted operations.

In some implementations, the method further includes in accordance with authentication of the semiconductor system, generating a root secret and storing the root secret permanently in a secure memory of the one or more semiconductor chips, and generating a plurality of keys based on the root secret.

In some implementations, each of the first and second keys is generated based on a combination of device specific secrets of the one or more semiconductor chips stored on a respective one of the computer and semiconductor system. Conversely, in some implementations, the challenge includes a sub-challenge for each chip, and the response includes a sub-response for each chip. The response includes a sub-response for each chip. Each chip is separately authenticated based on the sub-challenge and sub-response. The semiconductor system is authenticated for the subsequent operations in accordance with a determination that the sub-responses matches the sub-challenges for all of the one or more semiconductor chips.

In some implementations, the device identification and device specific secret of each chip are stored on the respective chip. Alternatively, in some implementations, the one or more semiconductor chips includes a main chip, and the device identification and device specific secret of each chip are consolidated and stored on the main chip.

In yet another aspect, a method of provisioning hardware is implemented at a semiconductor system (e.g., an SoC). The semiconductor system has one or more processors and a secure memory. The semiconductor system is coupled to a computer and includes one or more semiconductor chips. Each chip has a device identification and a device specific secret. The method includes while coupling to the computer, providing the device identification of each chip to the computer and receiving a challenge encrypted using a first key from the computer. The challenge is generated by the computer based on a random number and encrypted using the first key that is generated based on at least the device specific secret stored locally in the computer for each chip. The method includes generating a second key based on at least the device specific secret stored on the semiconductor system for each chip, and decrypting the challenge received from the computer to recover the random number using the second key. The method further includes generating a response based on the random number that is optionally modified, encrypting the response using the second key, and returning the response to the challenge. The computer is configured to determine whether the response matches the challenge and authenticate the semiconductor system for subsequent trusted operations (e.g., generating a root secret, creating keys based on the root secret, endorsing and certifying a public key).

Other implementations and advantages may be apparent to those skilled in the art in light of the descriptions and drawings in this specification.

### BRIEF DESCRIPTION OF THE DRAWINGS

FIG. 1A is a block diagram of an example electronic system in which a computer is coupled to an SoC, in accordance with some implementations.

FIG. 1B is a block diagram of an example electronic system in which a first computer is coupled to an SoC and a second computer, in accordance with some implementations.

FIG. 2 is a block diagram of an SoC configured to be provisioned with encryption keys based on die specific secrets, in accordance with some implementations.

FIG. 3 is a flow diagram of a provisioning process for creating and signing encryption keys for a semiconductor system, in accordance with some implementations.

FIG. 4 is a flow diagram of a provisioning process for creating and signing encryption keys for an SoC, in accordance with some implementations.

FIG. 5 illustrates data states of a plurality of data (e.g., SoC lifecycle state, root secret based keys, SoC device specific secret, root of trust (RoT) owner control) at touchpoints of an SoC production process, in accordance with some implementations.

FIG. 6 is a flow diagram of a method for provisioning hardware, in accordance with some implementations.

Like reference numerals refer to corresponding parts throughout the drawings.

### DESCRIPTION OF IMPLEMENTATIONS

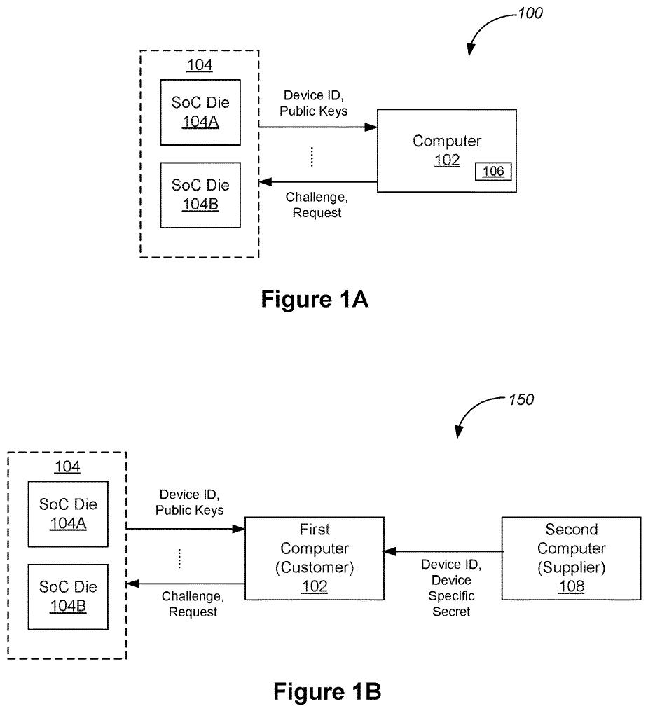

FIG. 1A is a block diagram of an example electronic system 100 in which a computer 102 is coupled to an SoC 104, in accordance with some implementations. The SoC 104 is implemented in a semiconductor package including one or more integrated circuits (e.g., SoC dies 104A and 104B). Each SoC die 104A or 104B integrates a subset of: one or more microprocessor or CPU cores, timing sources, peripherals (e.g., clocks, counter timers), RF communication modules, analog interfaces, power management circuits, memory, input/output ports, and secondary storage on a single substrate. When the SoC 104 is decoupled from the computer 102, the SoC can be applied in an electronic device that is distinct from the computer 102 and configured to implement digital, analog, mixed-signal, and/or radio frequency signal processing functions of the electronic device. In some implementations, the SoC 104 includes a main SoC die 104A and a companion SoC die 104B. In an example, main SoC die 104A includes one or more processor cores, and the companion SoC die 104B includes a memory, analog interfaces, or other components distinct from the processor cores.

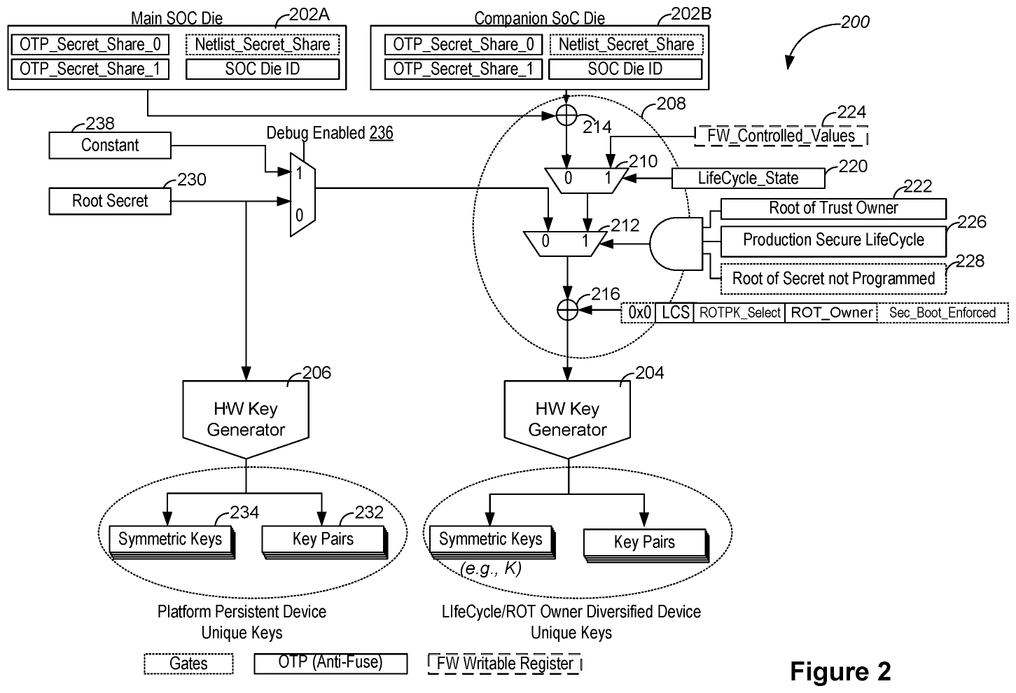

After the SoC dies of the SoC 104 are manufactured by the same foundry or distinct foundries, they are provided to a supplier for provisioning before the corresponding SoC 104 can be shipped to a customer who assembles the SoC 104 into the electronic device. The supplier uses the computer 102 to provision the SoC 104 after receiving the SoC 104 from the foundry. For example, the computer 102 includes a hardware security module (HSM) and is used in an assembly and test facility to provision the SoC 104 with a root secret (e.g., 230 in FIG. 2) and/or one or more encryption keys. The root secret and/or encryption keys are generated based on one or more die specific secrets of the SoC dies 104A-104B and stored in a secure memory of the SoC 104. In some implementations, the compute 102, which is controlled by the supplier of the SoC 104, reviews public keys stored in the secure memory of the SoC 104 and certifies the public keys.

In some implementations, the computer 102 is a standalone computing machine disconnected from any wired or wireless communication networks. This protects the computer 102 from tamper actions from the communication networks and helps maintain a high level of security for the computer 102. The computer maintains a local database 106 including information of the SoC dies 104A and 104B. For example, a device identification is associated with a device specific secret for each SoC die in the database 106. Conversely, the device identification and device specific secret of each SoC die are also stored on the SoC 104, optionally on the SoC die 104A, on the SoC 104B, or on the respective SoC die, during the course of manufacturing the SoC 104.

In some implementations, the computer 102 and SoC 104 operate according to a challenge-response protocol to provision the SoC 104 with the root secret and/or one or more encryption keys. The computer 102 pings the SoC 104 to obtain device identifications of the SoC dies, sends a challenge to the SoC 104 to authenticate the SoC 104, and sends a request to the SoC 104 to certify a public key. In some situations, public keys are communicated between the computer 102 and SoC 104. None of device specific secrets, root secret, and private keys is communicated between the computer 102 and SoC 104.

FIG. 1B is a block diagram of an example electronic system 150 in which a first computer 102 is coupled to a system on chip (SoC) 104 and a second computer 108, in accordance with some implementations. The first computer 102 is coupled to the SoC 104, and configured to provision the SoC 104 with the root secret and/or one or more encryption keys based on secrets that are specific to the SoC dies of the SoC 104. The first computer 102 does not store the device identification and device specific secret of each SoC die locally. Instead, the first computer 102 is coupled to the second computer 108, and obtains the device identification and device specific secret of each SoC die from the second computer 108. The first computer 102 then pings the SoC 104 to obtain device identifications of the SoC dies, sends a challenge to the SoC 104 to authenticate the SoC 104, and sends a request to the SoC 104 to certify a public key. In some implementations, the first computer 102 authenticates the SoC 104 based on the device identification and device specific secret of each SoC die, and controls the SoC 104 to generate a root secret and one or more keys. The root secret and keys are stored on the SoC 104, while public keys may be known to the first computer 102. The root secret and keys are confidential and unknown to the second computer 108.

In some situations, a supplier designs the SoC 104 and sets the device specific secret of each SoC die, and does not provision the SoC 104 with the root secret and keys. The supplier grants the right to provision the SoC 104 to a customer that purchases the SoC 104. The first computer 102 is used by the customer to provision the SoC 104 based on the device identification and device specific secret of each SoC die. This information of each SoC die is provided directly or indirectly by the second computer 108 controlled by the supplier.

FIG. 2 is a block diagram of a hardware key generation block 200 in an SoC 104 that is configured to be provisioned with a root secret 230 and keys 232 and 234 based on die specific secrets, in accordance with some implementations. The SoC 104 includes a memory for storing confidential data associated with individual SoC dies. In some implementations, the memory 202 is consolidated on one of the SoC dies of the SoC 104. In some implementations, the memory 202 is distributed among the SoC dies, and each SoC die 104A or 104B includes a portion of the memory (e.g., 202A or 202B) for storing confidential data of the respective SoC die. In an example, the memory 202 is an OTP memory. The confidential data stored on the memory 202 includes a device identification and a device specific secret of each SoC die. In some implementations, the memory 202 stores the device specific secret in a netlist.

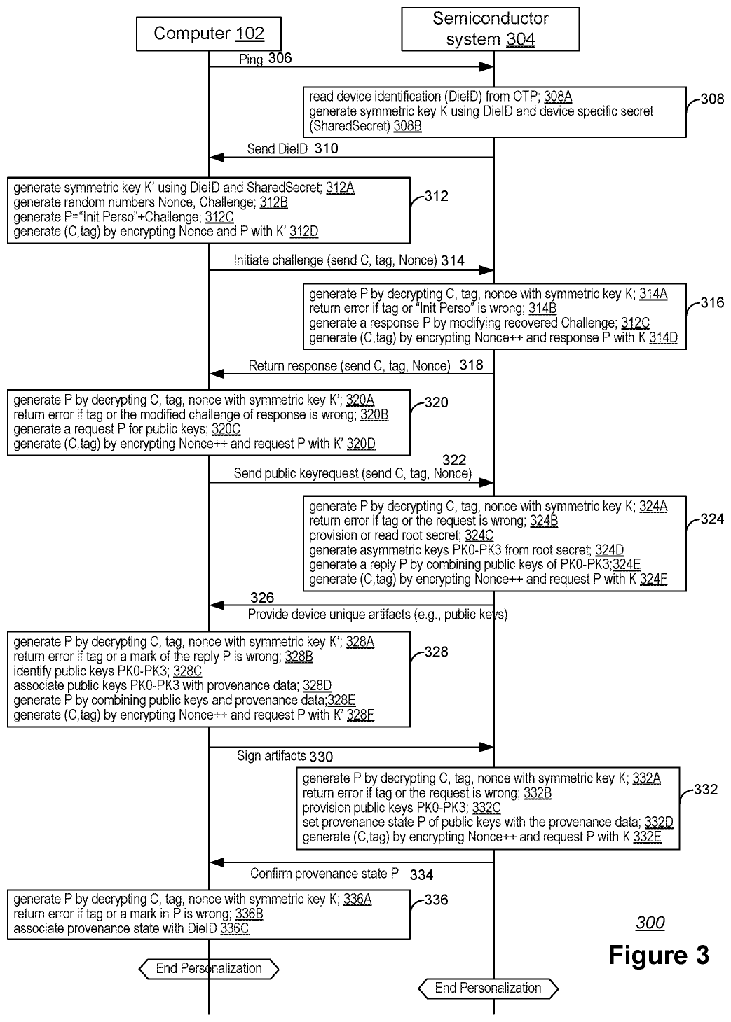

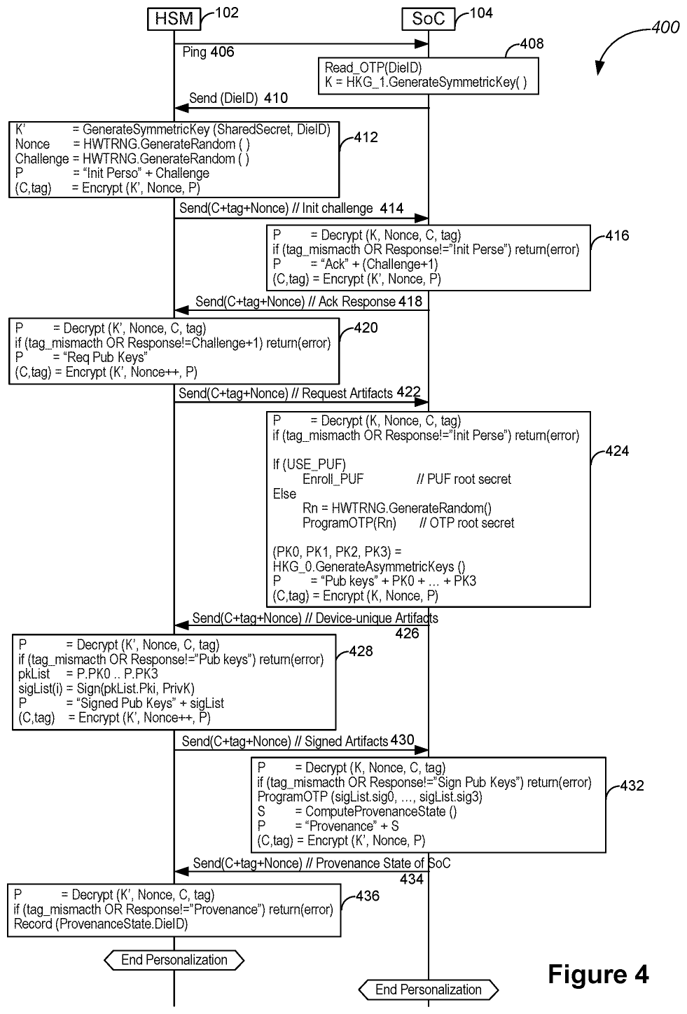

The SoC 104 includes two hardware key generators 204 and 206. The key generator 204 is coupled to the memory 202 and control signals received from the computer system 102, via control logic 208. In an example, the control logic 208 includes two multiplexers 210 and 212, two data combiners 214 and 216, and an AND gate 218. The control signals received from the computer system 102 include a lifecycle state 220 and a root of trust (RoT) owner control 222. The lifecycle state 220 is enabled after the SoC 104 is manufactured and shipped to a supplier/designer of the SoC 104. The lifecycle state 220 is used to control an access to data stored in the memory 202. A subset or all of the device identifications and device specifications of the SoC dies is extracted, combined by the data combiner 214, and outputted or used to generate a key (e.g., K in FIGS. 3 and 4). The lifecycle state 220 is applied to select one of an output of the data combiner 214 and a controlled value 224. The RoT owner control 222 is enabled for the supplier or a customer authorized by the supplier, but not by a manufacturer who has an access to the SoC during a manufacturing process. The RoT owner control 222 is used with one or more other control signals (e.g., production secure lifecycle 226 and root secret control 228) to select one of a root secret and an output of the combiner 214.

In some implementations, the control signals 220-228 are provided as part of a challenge sent by the computer 102. The challenge is encrypted by the computer device using a key K′ generated based on its own version of device specific secret. In the SoC 104, the device specification and device specific security of each SoC die are extracted and used to generate the key K. The key K is used to decrypt the challenge to obtain a random number and encrypt the random number (which is optionally modified) to form a response to the challenge. The response has to match the challenge by the computer system 102. As a result of this challenge-response process, the SoC 104 is authenticated by computer device 102 only if the device identification and device specific secret of each SoC die stored on the SoC 104 are consistent with those stored locally in a local database 106 of the computer 102.

After the SoC 104 is authenticated, a root secret 230 is generated and stored locally in the secure memory 202 by the SoC 104. In an example, the root secret 230 is a random number generated by the SoC 104. In some implementations, if a debug control 236 is disabled, the root secret 230 is used by the key generator 206 to generate a plurality of keys, including asymmetric key pairs 232 and symmetric keys 234. If the debug control 236 is enabled, a constant 238 is used by the key generator 206 to debug the key generator 206. In some implementations, the root secret 230, private keys of the asymmetric key pairs 232, the symmetric keys 234 are always stored on the secure memory 202 and not allowed to be transferred to any other devices including the computer 102. Only public keys of the asymmetric key pairs 232 are allowed to be shared with other devices including the computer 102.

FIG. 3 is a flow diagram of a provisioning process 300 for creating and signing encryption keys for a semiconductor system 304, in accordance with some implementations. The semiconductor system 304 includes one or more semiconductor chips each of which has a device identification and a device specific secret. The device identification and device specific secret of each chip may be stored separately on the respective chip or jointly in a secure memory of the semiconductor system 304. The device identification and device specific secret of each chip are formed during the course of manufacturing the semiconductor system 304 in a foundry. The semiconductor system 304 is coupled to a computer 102 configured to provision the semiconductor system 304 based on the device identifications and device specific secrets thereof. The computer 102 has a local database 106 including information of the one or more semiconductor chips. The device identification and device specific secret are associated with for each chip in the local database 106. As such, each of the computer 102 and semiconductor system 304 stores a copy of device specific secret of each chip of the semiconductor system 304, and the device specific secret of each chip is never communicated directly between the computer 102 and semiconductor system 304. In some implementations, this provisioning process 300 is implemented when a lifecycle state 220 is enabled and when the computer 102 provides a correct RoT owner control 222.

The computer 102 pings (306), i.e., sends a device identification request to, the semiconductor system 304 electrically coupled to the computer 102. In some implementations, at least a subset of the device identification and device specific secret of each chip is stored in a one time programmable (OTP) memory. The device identification and device specific secret of each chip of the semiconductor system 304 are read (308A) from the OTP memory by the semiconductor system 304, and used to generate (308B) a symmetric key K. The device identification of each chip is sent (310) to the computer 102, allowing the computer 102 to identify the device specific secret of each chip in the local database 106.

The computer 102 generates (312A) a symmetric key K′ using the device identification and device specific secret of each chip of the semiconductor system 304. The computer 102 generates (312B) two random number Nonce and Challenge, marks (312C) the random number Challenge with a mark “Init Perso”, and encrypts (312D) the random number Nonce and marked random number Challenge (i.e., P in 312) with the key K′ to generate a challenge message. The challenge message is sent (314) to the semiconductor system 304.

Upon receiving the challenge message, the semiconductor system 304 decrypts (316A) the challenge message with the key K to recover the marked random number Challenge (i.e., P in 312) and a tag, and returns (316B) an error message if the tag or the mark “Init Perso” is wrong. The semiconductor system 304 generates (316C) a response P by modifying the recovered random number Challenge (e.g., adding 1 to Challenge), and encrypts (316D) the random number Nonce that is optionally modified and the response P with the key K to generate a response message. The response message is sent (318) to the computer 102.

After receiving the response message, the computer 102 decrypts (320A) the response message with the key K′ to recover the response P and a tag, and returns (320B) an error message if the tag or the random number Challenge recovered from the response P is wrong. The computer 102 generates (320C) a request P for public keys, and encrypts (320D) the random number Nonce that is optionally modified and the request P with the key K′ to generate a request message. The request message is sent (322) to the semiconductor system 304, because the semiconductor system 304 is authenticated by the computer 102 in accordance with a determination that the response P received from the semiconductor system 304 matches the challenge issued by the computer 102.

Upon receiving the request message, the semiconductor system 304 decrypts (324A) the request message with the key K to recover the request P and a tag, and returns (324B) an error message if the tag or the request is wrong. If the semiconductor system 304 does not have a root secret 230, it generates (324C) the root secret 230; if the semiconductor system 304 already has the root secret 230, it extracts (324C) the root secret 230. The semiconductor system 304 generates (324D) asymmetric keys PK0-PK3 from the root secret 230, e.g., when a debug control 236 is disabled, and generates (324E) a reply P by combining the public keys of PK0-PK3. The semiconductor system 304 then encrypts (324E) the random number Nonce that is optionally modified and the reply P with the key K to generate a reply message. The reply message is sent (326) to the computer 102. The public keys of PK0-PK3 are device unique artifacts, and therefore, are provided to the computer 102 in the reply message in response to the request for public keys made by the computer 102.

After receiving the reply message, the computer 102 decrypts (328A) the reply message with the key K′ to recover the reply P and a tag, and returns (328B) an error message if the tag or a mark recovered from the reply P is wrong. The computer 102 identifies (328C) the public keys of PK0-PK3, and associates (328D) the public keys of PK0-PK3 with provenance data. The computer 102 generates (328E) a provenance request P combining the public keys of PK0-PK3 and the provenance data, and encrypts (328F) the random number Nonce that is optionally modified and the provenance request P with the key K′ to generate a provenance message. The provenance message is sent (330) to the semiconductor system 304 for the purposes of certifying and endorsing the device unique artifacts (e.g., the public keys of PK0-PK3).

Upon receiving the provenance message, the semiconductor system 304 decrypts (332A) the provenance message with the key K to recover the provenance request P and a tag, and returns (332B) an error message if the tag or the provenance request P is wrong. The semiconductor system 304 provisions (332C) the public keys of PK0-PK3, and sets (332D) a provenance state P of the public keys of PK0-PK3 according to the provenance data in the provenance request P. The semiconductor system 304 then encrypts (332E) the provenance state P with the key K to generate a provenance confirmation message. The provenance confirmation message is sent (334) to the computer 102.

After receiving the provenance confirmation message, the computer 102 decrypts (336A) the provenance confirmation message with the key K′ to recover the provenance state P and a tag, and returns (336B) an error message if the tag or a mark of the provenance state P is wrong. The computer 102 then associates the provenance state with the semiconductor system 304, indicating that the public keys of PK0-PK3 stored on the semiconductor system 304 have been certified and endorsed by the computer 102.

In accordance with the challenge-response protocol, the computer 102 generates a challenge based on a random number Challenge (e.g., in step 312 B), and encrypts the challenge using a first key K′ generated based on at least the device specific secret stored locally in the memory of the computer 102 for each chip. The challenge is sent to the semiconductor system 304 (e.g., in step 314). The computer 102 receives a response to the challenge from the semiconductor system 304 (e.g., in step 318). The response is generated based on the random number Challenge and is encrypted using a second key K that is generated by the semiconductor system based on at least the device specific secret stored on the semiconductor system 304 for each chip (e.g., in step 316). Each of the first key K′ and second key K may be generated based on both the device identification and device specific secret of each chip. The first and second keys K′ and K are optionally symmetric keys. In some implementations, the semiconductor system 304 is configured to modify the random number Challenge according to a predefined rule (e.g., adding the random number Challenge to 1) and generate and encrypt the response based on the modified random number (e.g., Challenge+1) (e.g., in step 316C). Upon receiving the response, the computer 102 determines whether the response matches the challenge (e.g., in step 320), and in accordance with a determination that the response matches the challenge, authenticates the semiconductor system for subsequent trusted operations. Examples of the trusted operations include, but are not limited to, generating the root secret 230 and symmetric or asymmetric keys (e.g., in step 324D) and endorsing public keys (e.g., in steps 328-336).

In some implementations, in accordance with authentication of the semiconductor system, the semiconductor system 304 generates a root secret 230 and stores the root secret 230 permanently in a secure memory of the one or more semiconductor chips (e.g., in step 324). The semiconductor system 304 generates a plurality of keys based on the root secret 230, and optionally stores the plurality of keys in the secure memory of the one or more semiconductor chips. In some implementations, the plurality of keys includes a pair of asymmetric keys having a public key and a private key. The computer 102 sends a request for the public key to the one or more semiconductor chips (e.g., in step 322), and receives the public key extracted from the secure memory of the one or more semiconductor chips (e.g., in step 326). The computer 102 combines the received public key with a provenance data associated with the computer to certify the public key (e.g., in step 328).

In some implementations, the first key K′ is generated based on a combination of device specific secrets of the one or more semiconductor chips, and the second key is also generated based on a combination of device specific secrets of the one or more semiconductor chips. The first and second keys K′ and K are symmetric keys. The semiconductor system 304 includes a processor configured to decrypt the challenge and generate the response based on the second key K to authenticate the semiconductor system 304 as a whole. Conversely, in some implementations, the challenge includes a sub-challenge for each chip, and the response includes a sub-response for each chip. For each chip, the computer 102 generates the sub-challenge based on a respective random number, and encrypts the sub-challenge using a respective first key K′ generated based on at least the device specific secret stored locally in the memory for the respective chip. The computer 102 receives the sub-response to the sub-challenge of the respective chip. The sub-response is generated based on the respective random number and is encrypted using a respective second key K that is generated based on at least the device specific secret stored on the semiconductor system 304. The computer 102 determines whether the sub-response matches sub-challenge. By these means, each chip is authenticated separately using the sub-challenge and sub-response, and the semiconductor system is authenticated for the subsequent operations in accordance with a determination that the sub-responses matches the sub-challenges for all of the one or more semiconductor chips.

In some implementations, the device specific secret of each chip is stored in the OTP memory of the semiconductor system 304. In an example, each device specific secret has 128 or 256 bits. After the root secret 230 and keys are generated and stored in the secure memory of the semiconductor system 304, the device specific secret are overwritten or permanently erased in the OTP memory of the semiconductor system 304. Corresponding memory units in the OTP memory is written with a predefined value, e.g., 0xFFFFFFFF . . . .

In some implementations, the one or more semiconductor chips include a main system-on-chip (SoC) die 104A and a companion SoC die 104B. After decoupled from the computer 102, the main and companion SoC dies 104A and 104B are configured to operate jointly as at least part of an SoC of an electronic device (e.g., a mobile device) distinct from the computer 102.

FIG. 4 is a flow diagram of a provisioning process 400 for creating and signing encryption keys for an SoC 104, in accordance with some implementations. The provisioning process 400 is consistent with the provisioning process 300, and operation steps of the provisioning process 400 are represented using program codes or formulas for clarification. The SoC 104 includes one or more SoC dies each of which has a die identification and a die specific secret. The die identification and die specific secret of each SoC die may be stored separately on the respective SoC die or jointly in a secure memory of the SoC 104. The die identification and die specific secret of each SoC die are formed during the course of manufacturing the SoC 104 in a foundry. The SoC 104 is coupled to a computer 102 (e.g., including HSM) configured to provision the SoC 104 based on the die identifications and die specific secrets thereof. The computer 102 has a local database 106 including information of the SoC dies. The die identification and die specific secret are associated with for each SoC die in the local database 106. As such, each of the computer 102 and SoC 104 stores a copy of die specific secret of each SoC die of the SoC 104, and the die specific secret of each SoC die is never communicated directly between the computer 102 and SoC 104.

The computer 102 obtains (406-410) the die identification and die specific secret of each chip, and generates (412) a challenge based on a random number Challenge, including encrypting the challenge using a first key K′ generated based on at least the die specific secret stored locally on the computer 102 in association with each SoC die (e.g., based on a combination of all of the die specific secrets of the SoC dies of the SoC 104). The computer 102 sends (414) the challenge to the SoC 104, and receives (418) a response to the challenge from the SoC 104. The response is based on the random number Challenge and is encrypted using a second key K that is generated by the SoC 104 based on at least the device specific secret of each SoC die stored on the SoC 104. The computer 102 determines (420) whether the response matches the challenge, and in accordance with a determination that the response matches the challenge, authenticates the SoC 104 for subsequent trusted operations.

In some implementations, in accordance with authentication of the SoC 104, the SoC 104 generates (424) a root secret 230 and stores the root secret 230 permanently in a secure memory of the SoC 104. The SoC 104 may generate (424) a plurality of keys (e.g., public keys PK0-PK3) based on the root secret 230. The keys are stored in the secure memory of the SoC 104 as well. In some implementations, the plurality of keys includes a pair of asymmetric keys having a public key and a private key. The computer 102 sends (422) a request for the public key to the SoC 104 and receives (426) the public key extracted from the secure memory of the SoC 104. In some implementations, the computer 102 combines (328) the received public key with a provenance data associated with the computer 102 to certify the public key.

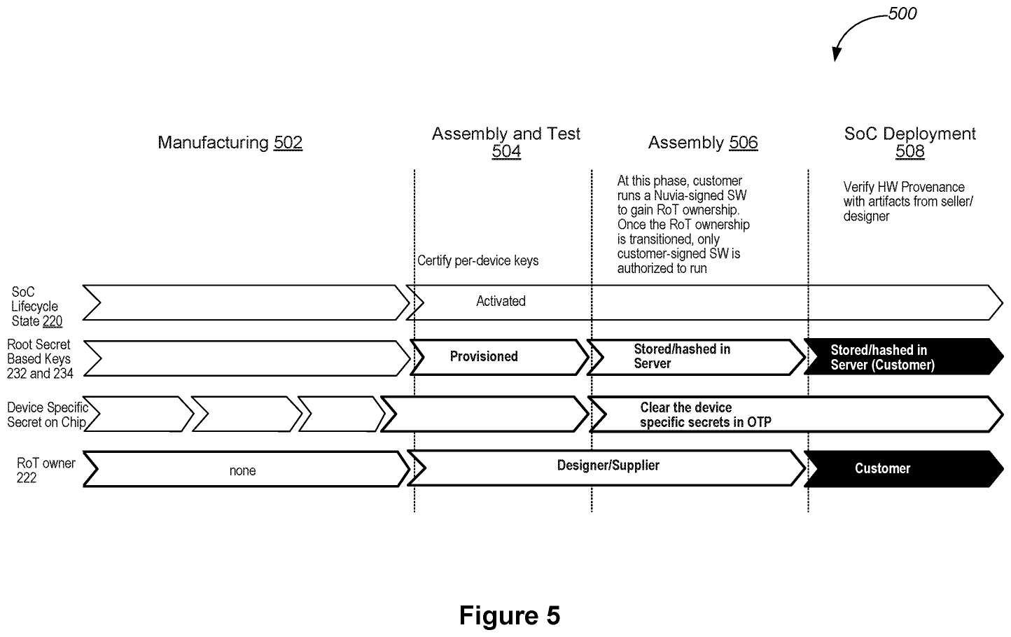

FIG. 5 illustrates data states 500 of a plurality of data (e.g., SoC lifecycle state 220, root secret 230 based keys 232 and 234, SoC device specific secret, RoT owner control 222) at a plurality of touchpoints of an SoC production process, in accordance with some implementations. The touchpoints of the SoC production process include manufacturing in the same foundry 502 or distinct foundries 502, intermediate assembly and test 504, final SoC assembly 506, and SoC deployment 508. The above described hardware provisioning methods 300 and 400 are implemented in the touchpoints 504-508.

The lifecycle state 220 and RoT owner control 222 are disabled during manufacturing 502, thereby prohibiting the foundries to tamper the SoC 104. Conversely, the lifecycle state 220 and RoT owner control 222 are enabled after manufacturing 502 and during intermediate assembly and test 504, final SoC assembly 506 and SoC deployment 508, thereby allowing a supplier and customer of the SoC 104 to provision the SoC 104 based on device specific secrets of the SoC 104.

In some implementations, keys 232 and 234 are not generated during manufacturing 502, and created based on the device specific secrets of the SoC 104 during intermediate assembly and test 506, which follows manufacturing 502 of the SoC 104. In some implementations, public keys of the asymmetric keys 232 are associated with the SoC 104 and stored in a server associated with the SoC (e.g., a supplier's server) during final SoC assembly 506. In some implementations, the public keys of the asymmetric keys 232 are associated with the SoC 104 and stored in another server associated with the SoC (e.g., a customer's server) during SoC deployment 508.

The device specific secrets of the SoC 104 are injected into the SoC 104 gradually with manufacturing steps during manufacturing 502, and can be read to generate keys during assembly and test 504. In some implementations, the device specific secrets of the SoC 104 are cleared from the secure memory of the SoC 104 during final assembly 506 or during SoC deployment 508.

Referring to FIG. 5, a method for securing access to an SOC 104 is implemented. During a first IC fabrication process 502 for a first IC die 104A, a predefined first cryptographic secret is injected into the first IC die 104A. The first IC die has stored therein a first die identification (ID) at a first touch point of the first IC fabrication process 502. During a second IC fabrication process 502 for a second IC die 104B, a second predefined cryptographic secret is injected into the second IC die 104B. The second IC die 104B has stored therein a second die identification (ID) at a second touch point of the second IC fabrication process 502. The first and second dies 104A and 104B with the SOC 104. During a test phase 504 for the SOC 104, a secure computer 102 (e.g., including a HSM) authenticates the first die 104A, the second die 104B or both via cryptographic challenges to the first die 104A, the second die 104B or both based on the secure computer's knowledge of the predefined first and second cryptographic secrets and the first and second die IDs associated with the first and second dies 104A and 104B. The first and second dies 104A and 104B are hardware-programmed to be able to use but not directly access the predefined first and second cryptographic secrets to respond to the cryptographic challenges.

In some implementations, when the authenticating is successful, the SoC 104 generates for one or more of the SOC, the first die, and the second die, a respective root secret, and stores the respective root secret permanently in a secure memory of the one or more of the SOC, the first die, and the second die. The SoC 104 generates a plurality of keys for the one or more of the SOC, the first die, and the second die based on the respective root secret.

In some implementations, the first and second IC fabrication processes 502 are performed independently of each other to provide the dies 104A and 104B. In some implementations, the association between the first and second dies 104A and 104B and the SOC 104 is entirely inaccessible to the first and second IC fabrication processes 502.

In some implementations, the secure computer 102 is an HSM. The HSM obtains the knowledge of the predefined first and second cryptographic secrets and the first and second die IDs associated with the first and second dies from a secure database 106. In some situations, the database 106 is accessible only to the HSM 102.

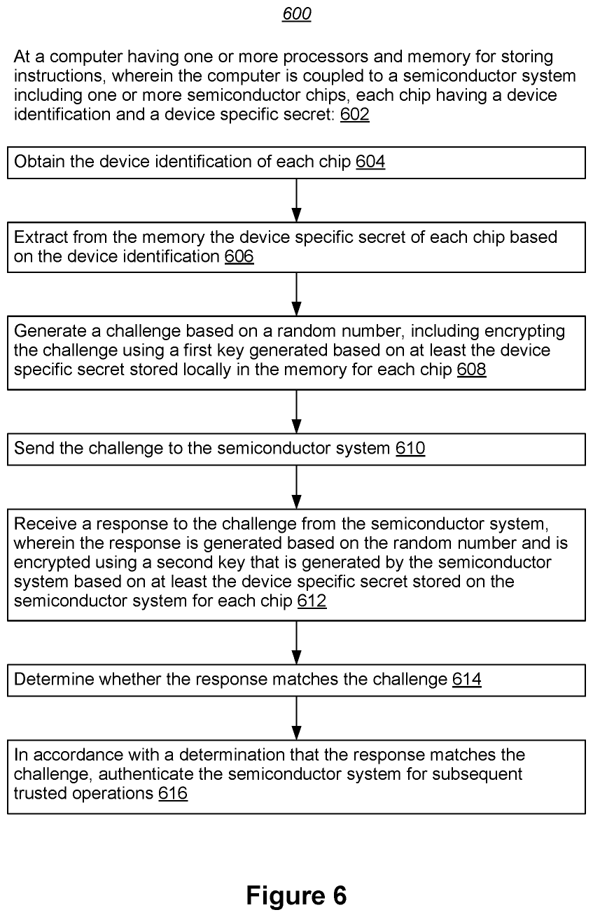

FIG. 6 is a flow diagram of a method 600 for provisioning hardware, in accordance with some implementations. The method 600 is implemented (602) at a computer (e.g., computer 102 in FIG. 1A) having one or more processors and memory for storing instructions. The computer is coupled to a semiconductor system (e.g., SoC 104) including one or more semiconductor chips (e.g., SoC dies 104A and 104B in FIG. 1A), and each chip has a device identification and a device specific secret. In some implementations, each chip is configured to store the device identification and device specific secret of the respective chip. In some implementations, the one or more semiconductor chips include at least two semiconductor chips. Further, in some implementations, the one or more semiconductor chips include a main chip configured to store the device identification and device specific secret of each chip

Method 600 is, optionally, governed by instructions that are stored in a non-transitory computer readable storage medium and that are executed by one or more processors of the computer system. Each of the operations shown in FIG. 6 may correspond to instructions stored in a computer memory or non-transitory computer readable storage medium. The computer readable storage medium may include a magnetic or optical disk storage device, solid state storage devices such as Flash memory, or other non-volatile memory device or devices. The instructions stored on the computer readable storage medium may include one or more of: source code, assembly language code, object code, or other instruction format that is interpreted by one or more processors. Some operations in method 600 may be combined and/or the order of some operations may be changed.

The computer obtains (604) the device identification of each chip and extracts (606) from the memory the device specific secret of each chip based on the device identification. A challenge is generated (608) based on a random number. The challenge is encrypted using a first key generated based on at least the device specific secret stored locally in the memory for each chip. The computer system sends (610) the challenge to the semiconductor system and receives (612) a response to the challenge from the semiconductor system. The response is generated based on the random number and is encrypted using a second key that is generated by the semiconductor system based on at least the device specific secret stored on the semiconductor system for each chip. The computer system determines (614) whether the response matches the challenge, and in accordance with a determination that the response matches the challenge, authenticates (616) the semiconductor system for subsequent trusted operations.

In some implementations, in accordance with authentication of the semiconductor system, the computer generates a root secret and stores the root secret permanently in a secure memory of the one or more semiconductor chips, and generates a plurality of keys based on the root secret. Further, in some implementations, the plurality of keys are stored in the secure memory of the one or more semiconductor chips. In some implementations, the plurality of keys include a pair of asymmetric keys having a public key and a private key. The computer sends a request for the public key to the one or more semiconductor chips, and receives the public key extracted from the secure memory of the one or more semiconductor chips in response to the request for the public key. The received public key is combined with a provenance data associated with the computer to certify the public key.

In some implementations, the first key is generated based on a combination of device specific secrets of the one or more semiconductor chips, and the second key is also generated based on a combination of device specific secrets of the one or more semiconductor chips. The first and second keys are symmetric keys.

In some implementations, the challenge includes a sub-challenge for each chip, and the response includes a sub-response for each chip. For each chip, the computer generates the sub-challenge based on a respective random number, and the sub-challenge is encrypted using a respective first key generated based on at least the device specific secret stored locally in the memory for the respective chip. The computer receives the sub-response to the sub-challenge of the respective chip. The sub-response is generated based on the respective random number and is encrypted using a respective second key that is generated based on at least the device specific secret stored on the semiconductor system. The computer determines whether the sub-response matches sub-challenge. The semiconductor system is authenticated for the subsequent operations in accordance with a determination that the sub-responses matches the sub-challenges for all of the one or more semiconductor chips.

In some implementations, the computer stores a database including information of the one or more semiconductor chips. For each chip, the computer associates the device identification and device specific secret in the database.

In some implementations, the computer including a first computer of a first user. The first computer obtains the device identification and device specific secret of each chip from a second computer of a second user. The one or more semiconductor chips are designed by the second user and sold to the first user. In accordance with authentication of the semiconductor system, the first computer generates a root secret and store the root secret permanently in a secure memory of the one or more semiconductor chips and generates one or more keys based on the root secret. The root secret and the one or more keys are unknown to the second user.

In some implementations, the device specific secret of each chip is stored in a one time programmable (OTP) memory of the semiconductor system. The device specific secret is overwritten in the OTP memory of the respective chip.

In some implementations, the one or more semiconductor chips include a main system on chip (SoC) die and a companion SoC die. The main and companion SoC dies are decoupled from the computer. The main and companion SoC dies are configured to operate jointly as at least part of an SoC of an electronic device distinct from the computer. Further, in some implementations, the SoC dies are configured to modify the random number according to a predefined rule and generate and encrypt the response based on the modified random number.

It should be understood that the particular order in which the operations in FIG. 8 have been described are merely exemplary and are not intended to indicate that the described order is the only order in which the operations could be performed. One of ordinary skill in the art would recognize various ways to annotate key points in images as described herein. Additionally, it should be noted that details of other processes described above with respect to FIGS. 2-8 are also applicable in an analogous manner to method 900 described above with respect to FIG. 9. For brevity, these details are not repeated here.

Clause 1. A method for provisioning hardware, comprising:

at a computer having one or more processors and memory for storing instructions, wherein the computer is coupled to a system on chip (SoC) including one or more SoC dies, each SoC die having a die identification and a die specific secret:
obtaining the device identification of each chip, and extracting from the memory the device specific secret of each chip based on the device identification;
generating a challenge based on a random number, including encrypting the challenge using a first key generated based on at least the die specific secret stored locally on the computer in association with each SoC die;
sending the challenge to the SoC;
receiving a response to the challenge from the SoC, wherein the response is based on the random number and is encrypted using a second key that is generated by the SoC based on at least the device specific secret of each SoC die stored on the SoC;
determining whether the response matches the challenge; and
in accordance with a determination that the response matches the challenge, authenticating the SoC for subsequent trusted operations.

Clause 2. The method of clause 1, further comprising, in accordance with authentication of the SoC, generating a root secret, generating a plurality of keys based on the root secret, and storing the root secret and the plurality of keys permanently in a secure memory of the SoC.

Clause 3. A method for securing access to an SOC, comprising:
during a first IC fabrication process for a first IC die, injecting a predefined first cryptographic secret into the first IC die, wherein the first IC die has stored therein a first die ID;
during a second IC fabrication process for a second IC die, injecting a second predefined cryptographic secret into the second IC die, wherein the second IC die has stored therein a second die ID;
associating the first and second dies with an SOC;
during a test phase for the SOC, authenticating by a secure computer the first die and the second die via cryptographic challenges to the first die and the second die based on the secure computer's knowledge of the predefined first and second cryptographic secrets and the first and second die IDs associated with the first and second dies, wherein the first and second dies are hardware-programmed to be able to use but not directly access the predefined first and second cryptographic secrets to respond to the cryptographic challenges.

Clause 4. The method of clause 3, further comprising: when the authenticating is successful, generating for one or more of the SOC, the first die, and the second die, a respective root secret, storing the respective root secret permanently in a secure memory of the one or more of the SOC, the first die, and the second die, and generating a plurality of keys for the one or more of the SOC, the first die, and the second die based on the respective root secret.

Clause 5. The method of clause 3 or 4, wherein the first and second IC fabrication processes are performed independently of each other.

Clause 6. The method of any of clauses 3-5, wherein the association between the first and second dies and the SOC is entirely inaccessible to the first and second IC fabrication processes.

Clause 7. The method of any of clauses 3-6, wherein the secure computer is an HSM. and the HSM obtains the knowledge of the predefined first and second cryptographic secrets and the first and second die IDs associated with the first and second dies from a secure database.

In one aspect, this application is directed to a method for provisioning hardware. A computer is coupled to a system on chip (SoC) including one or more SoC dies, and each SoC die has a die identification and a die specific secret. The computer obtains the device identification of each chip, and extracts from the memory the device specific secret of each chip based on the device identification. The computer generates a challenge based on a random number, including encrypting the challenge using a first key generated based on at least the die specific secret stored locally on the computer in association with each SoC die. The challenge is sent to the SoC. The computer receives a response to the challenge from the SoC, and the response is based on the random number and is encrypted using a second key that is generated by the SoC based on at least the device specific secret of each SoC die stored on the SoC. The computer determines whether the response matches the challenge and in accordance with a determination that the response matches the challenge, authenticates the SoC for subsequent trusted operations.

In another aspect, this application includes a method for securing access to an SOC. During a first IC fabrication process for a first IC die, a predefined first cryptographic secret is injected into the first IC die, wherein the first IC die has stored therein a first die ID. During a second IC fabrication process for a second IC die, a second predefined cryptographic secret is injected into the second IC die, wherein the second IC die has stored therein a second die ID. The first and second dies are associated with an SOC. During a test phase for the SOC, a secure computer authenticates the first die and the second die via cryptographic challenges to the first die and the second die based on the secure computer's knowledge of the predefined first and second cryptographic secrets and the first and second die IDs associated with the first and second dies. The first and second dies are hardware-programmed to be able to use but not directly access the predefined first and second cryptographic secrets to respond to the cryptographic challenges.

What is claimed is:

1. A method for provisioning hardware, comprising:
at a computer having one or more processors and memory for storing instructions, wherein the computer is coupled to a semiconductor system including one or more semiconductor chips, each chip having a device identification and a device specific secret:
obtaining the device identification of each chip, and extracting from the memory the device specific secret of each chip based on the device identification;
generating a challenge based on a random number, including encrypting the challenge using a first key generated based on at least the device specific secret stored locally in the memory for each chip;
sending the challenge to the semiconductor system;
receiving a response to the challenge from the semiconductor system, wherein the response is generated based on the random number and is encrypted using a second key that is generated by the semiconductor system based on at least the device specific secret stored on the semiconductor system for each chip;
determining whether the response matches the challenge; and
in accordance with a determination that the response matches the challenge, authenticating the semiconductor system for subsequent trusted operations.

2. The method of claim 1, further comprising:
in accordance with authentication of the semiconductor system:
generating a root secret and storing the root secret permanently in a secure memory of the one or more semiconductor chips; and
generating a plurality of keys based on the root secret.

3. The method of claim 2, further comprising:
storing the plurality of keys in the secure memory of the one or more semiconductor chips.

4. The method of claim 2, wherein the plurality of keys includes a pair of asymmetric keys having a public key and a private key, further comprising, at the computer:
sending a request for the public key to the one or more semiconductor chips; and
in response to the request for the public key, receiving the public key extracted from the secure memory of the one or more semiconductor chips; and
combining the received public key with a provenance data associated with the computer to certify the public key.

5. The method of claim 1, wherein the first key is generated based on a combination of device specific secrets of the one or more semiconductor chips, and the second key is also generated based on a combination of device specific secrets of the one or more semiconductor chips, the first and second keys being symmetric keys.

6. The method of claim 1, wherein the challenge includes a sub-challenge for each chip, and the response includes a sub-response for each chip, further comprising, for each chip:
generating the sub-challenge based on a respective random number, including encrypting the sub-challenge using a respective first key generated based on at least the device specific secret stored locally in the memory for the respective chip;
receiving the sub-response to the sub-challenge of the respective chip, wherein the sub-response is generated based on the respective random number and is encrypted using a respective second key that is generated based on at least the device specific secret stored on the semiconductor system; and
determining whether the sub-response matches sub-challenge, wherein the semiconductor system is authenticated for the subsequent trusted operations in accordance with a determination that the sub-responses matches the sub-challenges for all of the one or more semiconductor chips.

7. The method of claim 1, further comprising:
storing by the computer a database including information of the one or more semiconductor chips, including for each chip, associating the device identification and device specific secret in the database.

8. The method of claim 1, the computer including a first computer of a first user, further comprising, at the first computer:
obtaining the device identification and device specific secret of each chip from a second computer of a second user, wherein the one or more semiconductor chips are designed by the second user and sold to the first user; and
in accordance with authentication of the semiconductor system,
generating a root secret and store the root secret permanently in a secure memory of the one or more semiconductor chips; and
generating one or more keys based on the root secret;
wherein the root secret and the one or more keys are unknown to the second user.

9. The method of claim 1, wherein the device specific secret of each chip is stored in a one time programmable (OTP) memory of the semiconductor system, further comprising:
overwriting the device specific secret in the OTP memory of the respective chip.

10. A computer, comprising:
one or more processors, wherein the computer is coupled to a semiconductor system including one or more semiconductor chips, each chip having a device identification and a device specific secret; and
memory having instructions stored thereon, which when executed by the one or more processors cause the processors to perform operations including:
obtaining the device identification of each chip, and extracting from the memory the device specific secret of each chip based on the device identification;
generating a challenge based on a random number, including encrypting the challenge using a first key generated based on at least the device specific secret stored locally in the memory for each chip;
sending the challenge to the semiconductor system;
receiving a response to the challenge from the semiconductor system, wherein the response is generated based on the random number and is encrypted using a second key that is generated by the semiconductor system based on at least the device specific secret stored on the semiconductor system for each chip;
determining whether the response matches the challenge; and
in accordance with a determination that the response matches the challenge, authenticating the semiconductor system for subsequent trusted operations.

11. The computer of claim 10, wherein the one or more semiconductor chips include a main system on chip (SoC) die and a companion SoC die, further comprising:
decoupling the main and companion SoC dies from the computer, wherein the main and companion SoC dies are configured to operate jointly as at least part of an SoC of an electronic device distinct from the computer.

12. The computer of claim 11, wherein the SoC dies are configured to modify the random number according to a predefined rule and generate and encrypt the response based on the modified random number.

13. The computer of claim 10, where the one or more semiconductor chips include at least two semiconductor chips.

14. The computer of claim 13, where the one or more semiconductor chips include a main chip configured to store the device identification and device specific secret of each chip.

15. The computer of claim 10, wherein each chip is configured to store the device identification and device specific secret of the respective chip.

16. A non-transitory computer-readable medium, having instructions stored thereon, which when executed by one or more processors cause the one or more processors to perform operations comprising:
at a computer coupled to a semiconductor system including one or more semiconductor chips, each chip having a device identification and a device specific secret:
obtaining the device identification of each chip, and extracting from memory the device specific secret of each chip based on the device identification;
generating a challenge based on a random number, including encrypting the challenge using a first key generated based on at least the device specific secret stored locally in the memory for each chip;
sending the challenge to the semiconductor system;
receiving a response to the challenge from the semiconductor system, wherein the response is generated based on the random number and is encrypted using a second key that is generated by the semiconductor system based on at least the device specific secret stored on the semiconductor system for each chip;
determining whether the response matches the challenge; and
in accordance with a determination that the response matches the challenge, authenticating the semiconductor system for subsequent trusted operations.

17. The non-transitory computer-readable medium of claim 16, further comprising instructions for:
in accordance with authentication of the semiconductor system:
generating a root secret and storing the root secret permanently in a secure memory of the one or more semiconductor chips; and
generating a plurality of keys based on the root secret.

18. The non-transitory computer-readable medium of claim 17, further comprising instructions for:
storing the plurality of keys in the secure memory of the one or more semiconductor chips.

19. The non-transitory computer-readable medium of claim 17, wherein the plurality of keys includes a pair of asymmetric keys having a public key and a private key, further comprising instructions for, at the computer:
sending a request for the public key to the one or more semiconductor chips; and
in response to the request for the public key, receiving the public key extracted from the secure memory of the one or more semiconductor chips; and
combining the received public key with a provenance data associated with the computer to certify the public key.

20. The non-transitory computer-readable medium of claim 16, wherein the first key is generated based on a combination of device specific secrets of the one or more semiconductor chips, and the second key is also generated based on a combination of device specific secrets of the one or more semiconductor chips, the first and second keys being symmetric keys.
